(19) United States
(12) Patent Application Publication
(10) Pub. No.: US 2012/0118003 A1
(43) Pub. Date: May 17, 2012

(54) REFRIGERATED CONTAINER HAVING REFRIGERATION UNIT INTEGRATED WITH CARGO BOX

(75) Inventors: Dennis M. Stone, Cicero, NY (US); Harold Hill, Jamesville, NY (US); Lester G. Harrington, Lafayette, NY (US); Yu H. Chen, Manlius, NY (US); Kenneth Creswell, Cazenovia, NY (US); David F. Crockford, Fulton, NY (US)

(73) Assignee: CARRIER CORPORATION, Farmington, CT (US)

(21) Appl. No.: 13/387,180

(22) PCT Filed: Jul. 28, 2010
(86) PCT No.: PCT/US10/43459

§ 371 Date: Jan. 26, 2012

(30) Foreign Application Priority Data
Jul. 31, 2009 (US) 61230269

(51) Int. Cl. F25D 31/00; B23P 15/26

(52) U.S. Cl. 62/440; 29/890.035

(57) ABSTRACT

A refrigerated container includes a box-like structure having a floor, a pair of opposed side walls, a rear wall, and a roof panel defining an interior volume having an open forward end; and a refrigeration unit disposed in the forward end of the box-like structure and integrated into the box-like structure.

### CROSS REFERENCE TO RELATED APPLICATION

This application claims priority to U.S. Provisional Patent Application Ser. No. 61/230,269 entitled “Refrigerated Container Having Refrigeration Unit Integrated with Cargo Box,” filed on Jul. 31, 2009. The content of this application is incorporated herein by reference in their entirety.

### FIELD OF THE INVENTION

This invention relates generally to refrigerated containers and, more particularly, to integration of a self-contained refrigerant unit with the structure of a refrigerated container.

### BACKGROUND OF THE INVENTION

Refrigerated containers are commonly used for shipping perishable cargo, such as fresh produce, seafood, frozen products, and the other foods that must be maintained during transit at a temperature within a specified temperature range. Containers of this type are typically designed to accommodate transport by land on trailers, by sea on container ships, by rail on flat-bed train cars and even by air in cargo planes. Such versatile containers are commonly referred to as intermodal containers.

To facilitate placement within standard container cells on board ship and to comply with ISO standards, cargo containers of this type typically have a length of approximately twenty or forty feet (about 6.12 to 12.2 meters) in length, a height of about nine and one-half feet (about 2.9 meters), and a width of about eight feet (about 2.44 meters). The typical container comprises a box-like structure having a forward wall, a rear wall supporting a set of hinged doors, a pair of opposed side walls, a roof panel and a floor, thereby defining a cargo space within the box-like structure. The cargo is stacked within the cargo space, generally on pallets, disposed atop the floor of the container.

Many refrigerated containers in commercial in the shipping industry are equipped with a self-contained refrigeration unit secured to the front wall of the container. The refrigeration unit includes a compressor, a compressor motor, and a condenser unit isolated from the cargo space, and an evaporator unit operatively associated with the cargo space defined within the container. The condenser unit includes a refrigerant heat rejection heat exchanger and a condenser fan that draws ambient outdoor air through the condenser heat exchanger and discharges that air back into the outdoor environment. The evaporator unit includes a refrigerant heat absorption heat exchanger and one or more, typically two, evaporator fans which draw return air from the cargo space defined within the container through the evaporator heat exchanger for temperature conditioning and delivers that conditioned supply air back into the cargo space defined within the container. Although the refrigeration unit is typically operated in cooling mode to reduced the temperature of the return air, the refrigeration unit may be equipped with an auxiliary air heating device for heating the return air when the container is in transit in a region having an environment wherein the ambient outdoor temperature is below the desired temperature range in which the cargo in transit must be maintained.

In conventional practice, the self-contained refrigeration unit is formed as a pre-assembled unit that is flush mounted to the front wall of the container. The front wall of the container is provided with an aperture surrounded by a flange that extends inwardly about the perimeter of the aperture from the rectangular structural frame of the front wall. The self-contained refrigeration unit has a rectangular aluminum extrusion with flange extending outwardly from the housing of the refrigeration unit. To mount the refrigeration unit to the container, the refrigeration unit is inserted into the aperture in the front wall of the container until the flange extending about the perimeter of the refrigeration unit contacts the flange of the structural frame surrounding the aperture in the front wall of the container. The respective flanges are provided with bolt holes that match up when the refrigeration unit is properly inserted into the aperture. To secure the refrigeration unit in place, bolts are inserted into the bolt holes and secured in a conventional manner. For example, a cargo container having a pre-assembled, self-contained refrigeration unit bolted to front wall of the container is shown and described in European Patent Application Publication No. EP-0060724-A2.

In a conventional prior art container as above-described, the structural frame surrounding the aperture in the front wall of the container forms part of the overall support structure of the container. In addition to providing a surface on which to hang the refrigeration unit, this structural frame provides structural support for absorbing rack loading applied to the container when stacked one atop the other as typically occurs during transit on board a ship. The aluminum extrusion surrounding the perimeter of a conventional prior art refrigeration unit similarly provides structural support for absorbing rack loading applied to the container when stacked one atop the other.

### SUMMARY OF THE INVENTION

A refrigerated container includes a box-like structure having a floor, a pair of opposed side walls, a rear wall, and a roof panel defining an interior volume having an open forward end; and a refrigeration unit disposed in the forward end of the box-like structure and integrated into the box-like structure.

In an embodiment, the refrigeration unit may be welded to the box-like structure. The refrigeration unit may include a support frame that may be welded to the box-like structure of the container. The refrigerant unit may include a bulkhead built around the perimeter of the support frame of the refrigeration unit and the bulkhead of the refrigeration unit may be welded to box-like structure.

In an embodiment, a common structural member provides structural support for rack loading to both the box-like structure and the refrigeration unit. The refrigeration unit may be welded to the common structural member.

### BRIEF DESCRIPTION OF THE DRAWINGS

For a further understanding of the disclosure, reference will be made to the following detailed description which is to be read in connection with the accompanying drawing, where:

FIG. 1 is a perspective view of an exemplary embodiment of a refrigerated container having a refrigeration unit integrated with the container in accordance with the invention;

FIG. 2 is a perspective view from the back of the support frame of a conventional prior art refrigeration unit;

FIG. 3 is an exploded elevation view illustrating integration of a pre-assembled refrigeration unit to the front wall of the container in accordance with an exemplary embodiment of the invention;

FIG. 4 is an elevation view of the refrigeration unit shown in FIG. 3 installed into the container;

FIG. 5 is an elevation view of the support structure of the refrigeration unit shown in FIG. 3;

FIG. 6 is an elevation view of the support structure of the refrigeration unit shown in FIG. 5 prepared for shipment;

FIG. 7 is an exploded elevation view illustrating integration of a pre-assembled refrigeration unit to the front wall of the container in accordance with an exemplary embodiment of the invention; and

FIG. 8 is an elevation view of the refrigeration unit shown in FIG. 7 installed into the container.

### DETAILED DESCRIPTION OF THE INVENTION

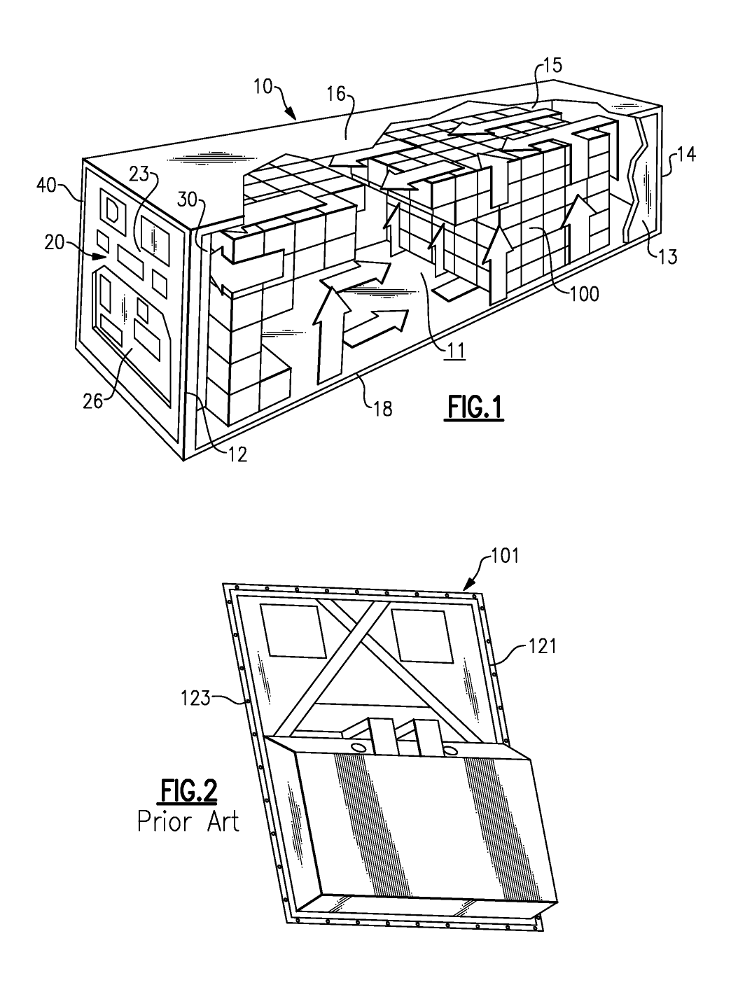

Referring initially to FIG. 1, there is depicted an exemplary embodiments of a refrigerated shipping container, generally referenced 10, having a refrigeration unit 20 integrated with the structural frame of the container 10. The cargo container 10 has a box-like structure formed of a forward or front wall 12, a back or rear wall 14 spaced longitudinally from the forward wall 12, a pair of opposed sidewalls 13 and 15 that extend longitudinally between the forward wall 12 and the rear wall 14, a roof panel 16 that extends longitudinally between an upper region of the forward wall 12 and an upper region of the rear wall 14 and that extends transversely between upper regions of the respective opposed side walls 13, 15, and a floor 18 that extends longitudinally between a lowermost region of the forward wall 12 and a lowermost region of the rear wall 14 and that extend transversely between lowermost regions of the respective opposed side walls 13, 15.

The box-like structure defines a cargo space 11 in which the bins, cartons or pallets of cargo 100 being transported are stacked on the floor 18. The rear wall 14 is provided with one or more doors (not shown) through which access to the cargo space may be had for loading the cargo 18 into the container 10. When the doors are closed, a substantially air-tight, sealed cargo space is established within the container 10 which prevents inside air from escaping the cargo space 11.

A refrigeration unit 20 is integrated into the forward wall 12 of the container 10 for conditioning the air within the cargo space 11 of the container 10. The refrigeration unit 20 includes a support structure for supporting a compressor (not shown) and an associated compressor drive motor (not shown) operatively associated with the compressor, mounted in the front section 26 of the refrigeration unit 20, a condenser module (not shown) isolated from the cargo space 11, and an evaporator module 30 operatively associated with the cargo space 11 defined within the container 10. The condenser module includes a refrigerant heat rejection heat exchanger (not shown) mounted to the support structure of the refrigeration unit 20 and positioned behind a panel 23, which covers the forward side of the refrigeration unit 20, and one or more condenser fans (not shown), and associated fan motors, (not shown) that draw ambient outdoor air through the condenser heat exchanger and discharge that air back into the outdoor environment.

The evaporator module 39, which is mounted on the back side of the support structure of the refrigeration unit 20, includes a refrigerant heat absorption heat exchanger (not shown) and one or more, typically two, evaporator fans (not shown), and associated fan motors (not shown), which draw return air from the cargo space 11 and passes the return air, and any fresh outdoor air that drawn through a fresh air inlet and mixed therewith as in conventional practice, through the evaporator heat exchanger for temperature conditioning and delivers that conditioned air as supply air back into the cargo space 11 defined within the container 10. Although the refrigeration unit 20 is typically operated in cooling mode to reduce the temperature of the return air, the refrigeration unit 20 may be equipped with an auxiliary air heating device (not shown) for heating the return air when the container 10 is in transit in a region having an environment wherein the ambient outdoor temperature is below the desired temperature range in which the cargo in transit must be maintained.

Referring now to FIG. 2, there is depicted therein a typical support frame 101 of a conventional prior art refrigeration unit. The support frame 101 includes the aforementioned flanged aluminum extrusion 121 having a plurality of bolt holes 123 in the flange to facilitate mounting of the assembled refrigeration unit to the structure frame of the front wall of the container as in conventional prior art practice. The refrigeration unit 20 disclosed herein lacks the aluminum extrusion with bolting flange that forms the perimeter of the support frame of the conventional prior art refrigerant unit and by which a conventional prior art refrigeration unit is bolted to the forward wall of the container. Rather than being bolted to the forward wall 12 of the container 10, the refrigeration unit 20 is integrated into the structure of the container 10 by sharing a common structural member that provides support for rack loading for not only the box-like structure, but also the refrigeration unit. In the exemplary embodiments depicted in FIGS. 3-6, the refrigeration unit 20 is welded to the common structural member.

Referring now to FIGS. 3 and 4, in the embodiment depicted therein, the front wall bulkhead frame 40 of the structure of the box-like container 10 serves as the common wall for providing rack loading support to the refrigeration unit 20. The container owner simply inserts the refrigeration unit 20 into the open front end of the container 10 and welds the structural members of the refrigeration unit 20 to the front wall bulkhead frame 40 surrounding and defining the open front end of the container 10. Unlike prior art bolted assemblies, neither the refrigeration unit 20 nor the bulkhead frame 40 of the container 10 has a perimeter bolting flange.

Since the bulkhead frame 40 has no flange extending inwardly therefrom, the open forward end of the container 10 into which the refrigeration unit is inserted is larger, by 6 to 12 inches (15.24 to 30.48 centimeters) in width and height than the aperture in the forward wall of a typical conventional ISO qualified container. The extra space available may be used to enlarge the evaporator and/or condenser of the refrigeration unit 20, as desired. Further, welding the refrigeration unit 20 directly to the structural bulkhead frame 40 of the container 10 provides for better structural strength of the container 10 and reduces the potential for air leakage around the refrigeration unit 20 as a seal member between the bolted flanges associated with conventional prior art refrigerated containers is eliminated.

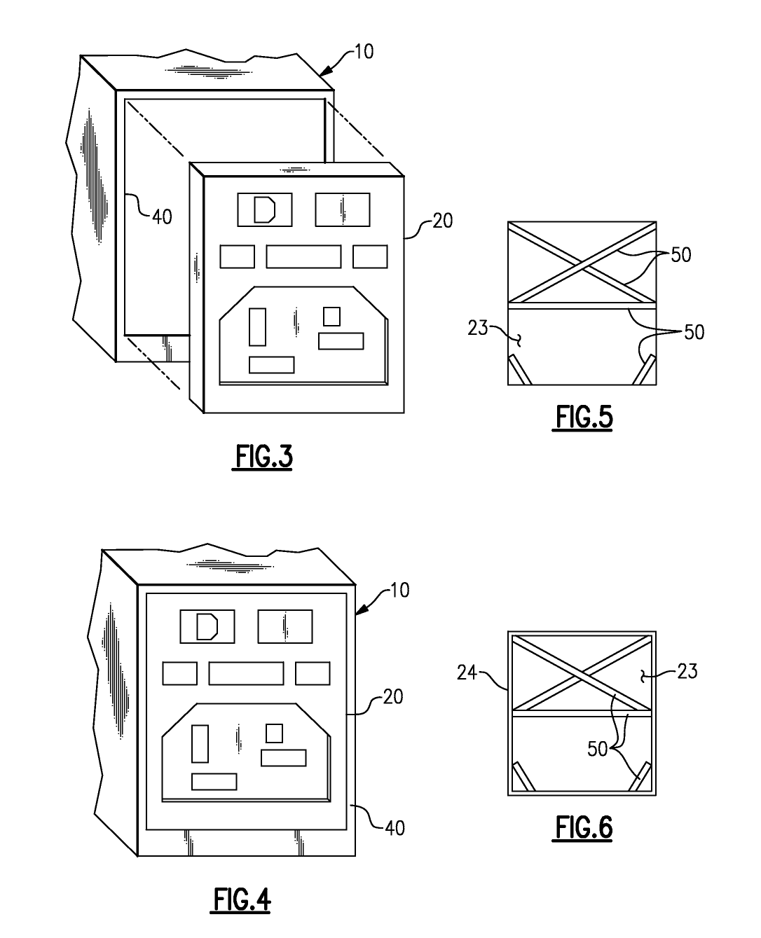

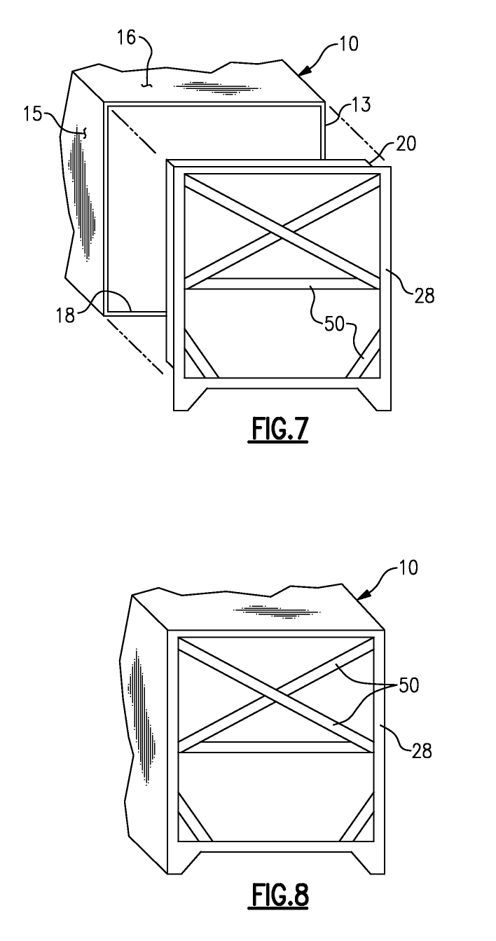

As noted previously, in the embodiment depicted in FIGS. 3 and 4, the refrigeration unit 20, lacks the aluminum extrusion structural member extending about the perimeter of the unit. The condenser module and the evaporator module and other components are mounted to various support members. However, as illustrated in FIG. 5, the various support members 50, and the sheet metal panel 23 mounted thereto, are not connected to a surrounding structural perimeter member, such as the aluminum extrusion on a conventional prior art unit. Because the refrigeration unit 20 is welded to the bulkhead frame 40 of the container structure, the structure perimeter member common to prior art units is now redundant and may be eliminated thereby reducing the weight and cost of the refrigeration unit. As illustrated in FIG. 6, for protection, a fixture 24 may applied about the edge perimeter of the self-contained refrigeration unit 20 prior to shipping.

Referring now to FIGS. 7 and 8, in the depicted embodiment, a bulkhead 28 is built around the refrigeration unit 20 prior to shipping the refrigeration unit for assembly to the container 10. In this scenario, the container 10 is pre-built without a front end bulkhead frame 40. The refrigerant unit bulkhead 28 replaces the front wall bulkhead frame 40 of the container 10. The container manufacturer simply inserts the refrigeration unit 20 with its surrounding bulkhead 28 assembly into the open front end of the container 10 and welds the bulkhead 28 to the side walls 14, 15, the floor 18 and roof panel 16. Thus, the refrigeration unit bulkhead 28 becomes an integral part of the support structure of the container 10.

The refrigeration unit 20 may, if desired, be installed in the container 10 in a partially assembled state, rather than in a fully assembled state. For example, the refrigeration unit 20 may be installed in the container 10 in the manners described hereinbefore with the evaporator module 30 mounted to the rear side of the support members 50, but without the condenser module or compressor or other components normally mounted to the front side of the support members 50 includes. The condenser module, compressor or other components normally mounted to the front side of the support members 50 may be easily installed from outside of the container 10 after the partially assembled refrigeration unit is installed in the container and welded in place. Installing the refrigeration unit 20 into the container 20 in a partially assembled state, rather than a fully assembled, may be desired in some instances to facilitate the welding process.

In either of the above-discussed embodiments, the structural integrity of the refrigerated container 10 is improved by integrating the refrigeration unit 20 into the structure of the container 10, rather than by simply bolting the refrigeration unit to the container's forward wall as in conventional practice.

The terminology used herein is for the purpose of description, not limitation. Specific structural and functional details disclosed herein are not to be interpreted as limiting, but merely as basis for teaching one skilled in the art to employ the present invention. While the present invention has been particularly shown and described with reference to the exemplary embodiments as illustrated in the drawing, it will be recognized by those skilled in the art that various modifications may be made without departing from the spirit and scope of the invention. Those skilled in the art will also recognize the equivalents that may be substituted for elements described with reference to the exemplary embodiments disclosed herein without departing from the scope of the present invention.

Therefore, it is intended that the present disclosure not be limited to the particular embodiment(s) disclosed as, but that the disclosure will include all embodiments falling within the scope of the appended claims.

We claim:

1. A refrigerated container comprising:
a box-like structure having a floor, a pair of opposed side walls, a rear wall, and a roof panel defining an interior volume having an open forward end; and
a refrigeration unit disposed in the forward end of said box-like structure and being welded to said box-like structure.

2. The refrigerated container as recited in claim 1 wherein the refrigeration unit includes a support structure, said support structure being welded to said box-like structure.

3. The refrigerated container as recited in claim 2 wherein said support structure includes a bulkhead built around the perimeter of the support frame.

4. The refrigerated container as recited in claim 3 wherein said bulkhead of the refrigeration unit is welded to said box-like structure.

5. A refrigerated container comprising:
a box-like structure having a floor, a pair of opposed side walls, a rear wall, and a roof panel defining an interior volume having an open forward end;
a refrigeration unit disposed in the forward end of said box-like structure; and
a common structural member providing structural support for rack loading to both the box-like structure and the refrigeration unit.

6. The refrigerated container as recited in claim 5 wherein said refrigeration unit is welded to the common structural member.

7. A method of assembled a refrigeration unit to a transport refrigeration container comprising the steps of:
providing a common structural member for providing structural support to the refrigeration unit and the container.

8. The method as recited in claim 7 wherein the step of providing a structural member for providing structural support to the refrigeration unit and the container comprises welding the refrigeration unit directly to a support structure of the container.

9. The method as recited in claim 7 wherein the step of providing a structural member for providing structural support to the refrigeration unit and the container comprises providing a bulkhead frame about the perimeter of the refrigeration unit, inserting the refrigeration unit and bulkhead frame assembly into an opening in the container, and welding said bulkhead frame and the container together.
